(19) United States
(12) Patent Application Publication
(10) Pub. No.: US 2025/0122853 A1
(43) Pub. Date: Apr. 17, 2025

(54) FUEL INJECTOR WITH SEALING MEMBER

(71) Applicant: Caterpillar Inc., Peoria, IL (US)

(72) Inventor: Hoisan KIM, Dunlap, IL (US)

(73) Assignee: Caterpillar Inc., Peoria, IL (US)

(21) Appl. No.: 18/488,574

(22) Filed: Oct. 17, 2023

(51) Int. Cl. F02M 51/00; H02G 15/013

(52) U.S. Cl. CPC F02M 51/005; H02G 15/013

(57) ABSTRACT

A fuel injector includes a body assembly having a proximal end and a distal end comprising a nozzle, an electronically operated valve situated within the body assembly, the electronically operated valve comprising a plurality of electrical wires, and a passageway configured to convey electrical wires from the electronically operated valve proximally through the fuel injector and out the proximal end and external to the body assembly. The fuel injector further includes a seal situated within the passageway and distal a proximal end of the passageway, the seal surrounding the plurality of electrical wires.

### TECHNICAL FIELD

The present disclosure relates generally to systems for internal combustion engine components, and more particularly, to a fuel injector including a sealing member.

### BACKGROUND

Fuel injectors are used in internal combustion engines to control fuel delivery to combustion cylinders, where the fuel is ignited. The timing and operation of a fuel injector is regulated by a control module that sends electrical signals via a physical wire having a male/female-type electrical connector. However, due to the electrical connector's close proximity to the engine pistons, it is subjected to severe vibrations and is prone to leaking fuel, pin arcing, or becoming disconnected from the fuel injector assembly.

U.S. Pat. No. 6,939,178, issued on Sep. 6, 2005 (“the '178 patent”), describes an electrical connector that attaches a fuel injector assembly to a vehicle control assembly. The electrical connector of the '178 patent comprises a plastic molded body having two integrally formed portions, a base portion and a stem portion, and an electrical contact extending through the body from the stem portion to the base portion. The base is inserted into the fuel injector assembly with the electrical contact engaging a corresponding contact within the fuel injector assembly. Similarly, the electrical contact in the stem portion of the connector is attached to a corresponding contact of a control assembly, which provides the electrical signals to operate the fuel injector. While the '178 patent discloses a connector for a fuel injector assembly, the connector may be subject to detrimental disconnection or fuel leaking resulting from vibrations of the engine.

The fuel injector electrical connection assembly of the present disclosure may solve one or more of the problems set forth above and/or other problems in the art. The scope of the current disclosure, however, is defined by the attached claims, and not by the ability to solve any specific problem.

### SUMMARY

According to one aspect of the present disclosure, a fuel injector includes a body assembly having a proximal end and a distal end comprising a nozzle, an electronically operated valve situated within the body assembly, the electronically operated valve comprising a plurality of electrical wires, and a passageway configured to convey electrical wires from the electronically operated valve proximally through the fuel injector and out the proximal end and external to the body assembly. The fuel injector further includes a seal situated within the passageway and distal a proximal end of the passageway, the seal surrounding the plurality of electrical wires.

According to another aspect of the disclosure, a fuel injector includes a body assembly comprising a proximal end and a distal end comprising a nozzle, an electronically operated valve situated within the body assembly, the electronically operated valve comprising a plurality of electrical wires having a distal end connected inside the body assembly and a proximal end extending outside the body assembly to an electrical connector, and a passageway configured to convey the plurality of electrical wires from the electronically operated valve proximally through the body assembly to the proximal end of the body assembly. The fuel injector further includes a seal situated within the passageway and comprising a plurality of lumens extending from a seal proximal end to a seal distal end, each of the plurality of lumens receiving a wire of the plurality of electrical wires.

According to yet another aspect, the a fuel injector includes a body assembly comprising a proximal end and a distal end comprising a nozzle, an electronically operated valve situated within the body assembly, the electronically operated valve comprising a plurality of electrical wires having a distal end connected inside the body assembly and a proximal end extending outside the body assembly to an electrical connector, and a passageway configured to convey the plurality of electrical wires from the electronically operated valve proximally through the body assembly to the proximal end of the body assembly. The fuel injector further includes a seal situated within the passageway and distal a proximal end of the passageway, the seal including a plurality of individual members; and a plurality of lumens extending from a seal proximal end to a seal distal end, each of the plurality of lumens receiving a wire of the plurality of electrical wires.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic cross-sectional view of a dual-fuel fuel injector, according to various aspects of the disclosure;

FIG. 2 is an enlarged cross-sectional view of a sealing member contained within a dual-fuel injector, according to various aspects of the disclosure; and

FIG. 3 is a simplified exploded view of a sealing member and surrounding plates of a dual-fuel injector, according to various aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about.” “substantially,” and “approximately” are used to indicate a possible variation of +10% in the stated value.

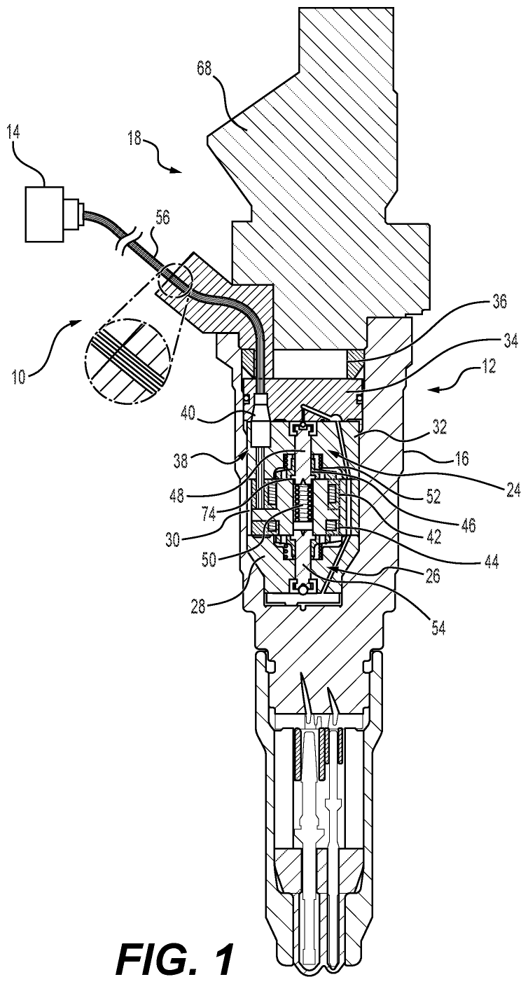

FIG. 1 illustrates an exemplary fuel injector system 10 for an internal combustion engine (ICE) according to various aspects of the present disclosure. Fuel injector system 10 may include a fuel injector body assembly (or fuel injector) 12 that is electronically connected to a fuel injector controller 14. Fuel injector 12 may be an electronically-controlled unit injector that is operated at least in part by controller 14. As shown in FIG. 1, fuel injector system 10 may be a dual-fuel type fuel injector system; however, the present disclosure may be used with any type of fuel injector system (e.g., single fuel gaseous fuel or single fuel diesel fuel injector systems). Fuel injector body assembly 12 includes an injector housing 16 forming an exterior body of fuel injector 12 with a proximal inlet end portion 18, and a distal outlet or nozzle end portion 20. As will be described in more detail below, fuel injector 12 may include a plurality of stacked plates within injector housing 16 providing fuel flow passages and positioning one or more electronic or solenoid-type valves. Controller 14 is connected to the one or more electronic valves via a wire connection extending through one or more of the stacked plates. The wire connection includes a plurality of wires 56 and a seal 40 to assist in sealing fuel from leaking from the fuel injector body assembly 12.

Fuel injector housing 16 may include various passages for fuel, and not all passages are shown in FIG. 1 or discussed herein. The various passages for fuel include high-pressure passages, low-pressure passages, and leak/drain passages. The electronically operated valves control the opening and closing of the various passages, and may include, for example, a spill valve 24 and a control valve 26. As noted above, fuel injector 12 is an example of a dual-fuel injector and may include two separate nozzles that facilitate combustion of two different types of fuel, such as a gas outlet nozzle and liquid fuel outlet nozzle.

The electronic or solenoid operated valves (e.g. spill valve 24, and control valve 26) of fuel injector 12 may include one or more solenoids, an armature, valve members, a valve seat, springs to bias the valve, and wires for controlling the one or more solenoids. The one or more solenoids of the electronic valves may be arranged within plates or valve bodies of fuel injector housing 16. As used herein, the term “plates” may include “valve bodies,” “valve plates”, and “injector plates.” and the terms may all be interchangeable. The various plates and valve bodies may be stacked together. For example, as shown in FIG. 1, control valve 26 may include a control valve body 28 located at the distal end of a portion of injector housing 16. A solenoid body 30 may be located proximally adjacent to control valve body 28. Spill valve body 32 may be located proximally adjacent to solenoid body 30. Spill plate 34 may be located proximally to spill valve body 32. Compression nut 36 is located proximally to spill plate 34. Compression nut 36 may include threads that facilitate fastening with injector housing 16. Each plate and/or valve body meets at an interface. An interface between plates may be a point of leaking of fuel.

Spill valve 24 includes spill valve body 32 that defines a spill valve bore 46. Spill valve 24 may be a normally-open valve including a valve member 48 that is movable between an open position and a closed position. A spring member 50 may act to bias spill valve member 48 to the open position by urging spill valve member 48 out of contact with spill valve seat 74. When the valve member 48 is in the open position, a primary fuel passage may be connected to a low-pressure fuel drain. When in the closed position, spill valve 24 may prevent the fuel from exiting injector 12, enabling pressurization of this fuel. Spill valve 24 may be actuated via a spill valve solenoid 42 that actuates a spill valve armature 52 fixed to spill valve member 48.

Control valve 26 may include a control valve member 54 having a non-injection position and an injection position. Control valve member 54 may be configured to connect a low-pressure fuel passage with a control chamber when in the injection position, and block the connection between the low-pressure fuel passage and the control chamber when in the non-injection position. Control valve 26 may be actuated via a control valve solenoid 44 that actuates a control valve armature fixed to control valve member 54.

At least some of the stacked injector plates within injector housing 16 may include a passageway 38 extending in a proximal-distal direction through the plates. Electrical wires 56 may be conveyed via passageway 38 from solenoid body 30, through injector housing 16 and out the proximal end of the fuel injector 12 and external to the injector housing 16. The proximal end of wires 56 may terminate at an electrical connector that is connected to controller 14. Wires 56 extend through seal 40, which is located within passageway 38. Seal 40 may insulate wires 56 from the injector plates and may provide a conduit for wires 56 along their path between injector housing 16 and solenoid body 30. Electrical wires 56 may be connected to the solenoids via a pin and socket connection, or wires 56 may be welded to the terminals of the solenoids 42, 44. Electrical wires 56 may be used to control one or more solenoids, including solenoid 42 that actuates spill valve 24, and solenoid 44 that controls control valve 26. Electrical wires 56 may also be used to communicate information from the one or more electronic valves 24, 26 to controller 14. In some embodiments, two pairs of electrical wires 56 (four wires total) are conveyed through passageway 38. However, any number of electrical wires may be conveyed through passageway 38 or seal 40.

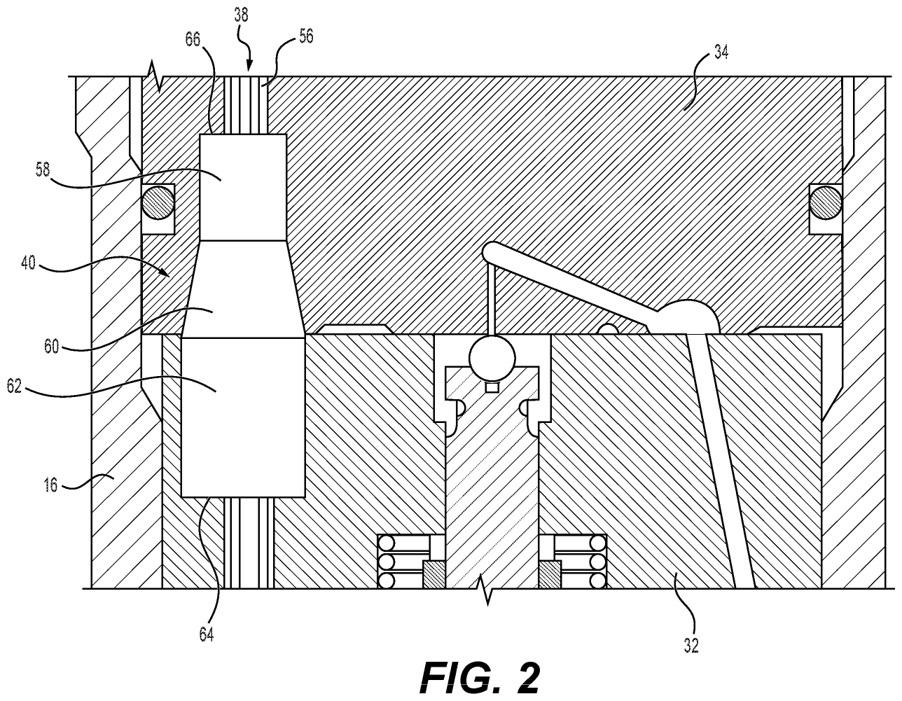

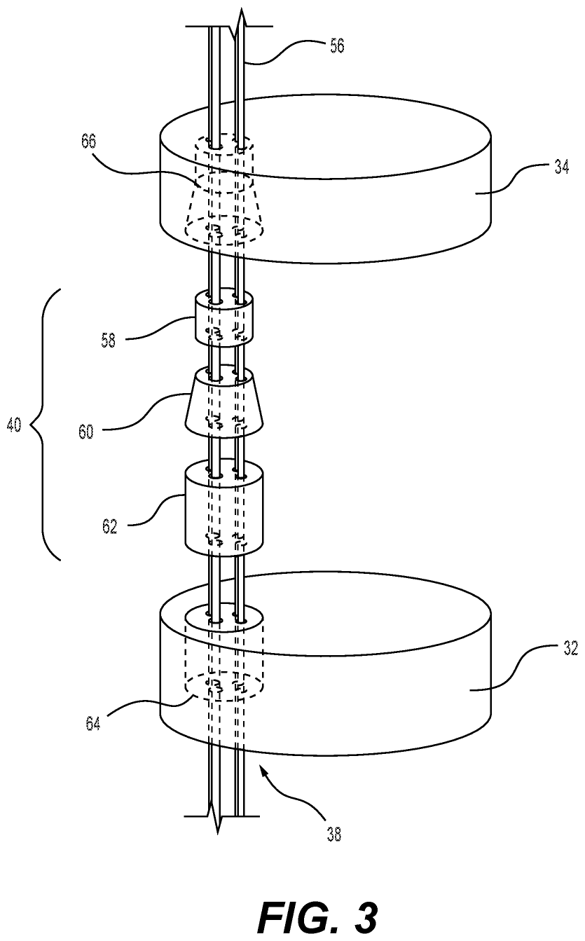

FIG. 2 is an enlarged cross-sectional view of spill plate 34, spill valve body 32, and seal or sealing member 40 of fuel injector 10. Seal 40 may include three individual members (e.g., an upper sealing member 58, a central sealing member 60, and a lower sealing member 62) that are not fastened together, but are forced together such that each abuts the other. While three sealing members are disclosed, it is understood that seal 40 could be formed of a single member, two members, or more than three members. Upper sealing member 58 may be cylindrical and may be located at a proximal end of seal 40. Central sealing member 60 includes a taper and is shaped like a truncated cone. Central sealing member 60 is centrally located between upper sealing member 58 and lower sealing member 62. Lower sealing member 62 may be cylindrical and is located at a distal end of seal 40. The cylinder radius of lower sealing member 62 may be greater than the cylinder radius of upper sealing member 58. The cylinder radius of upper sealing member 58 may be the same as the proximal radius of the truncated cone shape of central sealing member 60, while the cylinder radius of the lower sealing member 62 is the same as the distal radius of the truncated cone shape of central sealing member 60. Each of the three individual sealing members includes at least two lumens or wire passageways extending completely through from the distal end of each member to the proximal end of each member. As shown best in FIG. 3, four wire lumens are included in each sealing member. When the individual sealing members are forced together, continuous lumens are formed from a proximal end of seal 40 to a distal end of seal 40. It is understood, however, that additional or less lumens may be included in the seal 40. The lumens of each of the three individual sealing members are aligned to receive individual electrical wires 56 such that the wires may pass through all three individual sealing members 58, 60, 62 extending from a distal end of seal 40 to a proximal end of seal 40.

Lower sealing member 62 is located substantially in passageway 38 of spill valve body 32. The proximal end of lower sealing member 62 may extend past or proximal the interface 33 between spill valve body 32 and spill plate 34. Lower sealing member 62 may abut a distal step 64 in passageway 38, which is located in spill valve body 32.

Upper sealing member 58 and central sealing member 60 are also located substantially within passageway 38, but are located within spill plate 34. Upper sealing member 58 abuts a proximal step 66 in passageway 38, which is located in spill plate 34. In some embodiments, upper sealing member 58 and central sealing member 60 may be combined into a single individual member.

Passageway 38 may include a taper within spill plate 34 near the interface of spill plate 34 and spill valve body 32. The taper in passageway 38 may have a similar angle as the taper of central sealing member 60. In some embodiments, the taper in passageway 38 has an angle that is less than the taper of central sealing member 60 to ensure a leak-proof contact.

The individual members of seal 40 may be formed of different materials. For example, central sealing member 60 may be formed of an elastomer material while upper sealing member 58 and lower sealing member 62 may be formed of a hard, non-elastic material. In some embodiments, upper sealing member 58 and lower sealing member 62 may be formed of ceramic or polyether ether ketone (PEEK). It is contemplated, however, that the individual scaling member 58, 60, and 62 could be formed of the same material.

FIG. 3 is a simplified exploded view of seal 40 and surrounding plates and members, according to various aspects of the present disclosure. Spill valve body 32, as depicted in FIG. 3, is simplified such that elements of spill valve body 32 are not shown, such as spill valve bore 46, spill valve member 48, or spill valve armature 52. Spill plate 34 is similarly simplified in FIG. 3 such that fuel passages and recesses in spill plate 34 are not shown. The three individual sealing members of seal 40 include upper sealing member 58, central sealing member 60, and lower scaling member 62. Upper sealing member 58 and central scaling member 60 may fit into passageway 38 in spill plate 34 and abut step 66 in passageway 38 that extends through spill plate 34. Lower scaling member 62 fits into passageway 38 that extends through spill valve body 32 and abuts step 64 in passageway 38. Electrical wires 56 are conveyed through passageway 38 and through individual lumens that extend through each individual member of seal 40. As noted above, while two pairs of electrical wires are shown in FIG. 3, more or less wires may be used in different embodiments.

### INDUSTRIAL APPLICABILITY

The fuel injector system disclosed herein may be applied to any internal combustion engine (ICE) utilizing electronically-controlled fuel injectors. Fuel injector 12 may be utilized to assist in generating power in a stationary machine (e.g., a generator or other electricity-generating device), in a mobile machine (e.g., an earthmoving device, a hauling truck, a drilling machine, etc.), or in other applications in which it may be beneficial to operate an engine, including engines that utilize a plurality of different fuels. Fuel injection system 10 may generate electrical power, motive power, and/or may provide power for operating one or more associated systems, such as hydraulic systems.

Fuel injector 12 may receive fuel from a primary fuel connection 68 prior to a fuel injection event. Fuel may flow through various passages and chambers within fuel injector housing 16. Electronically controlled valves such as spill valve 24 and control valve 26 are operated or controlled via signals sent through electrical wires 56. Spill valve 24 and control valve 26 are used to facilitate pressure build-up and flow of liquefied diesel fuel, while gaseous fuels bypass spill valve 24 and control valve 26. Spill valve 24 and control valve 26 are used to facilitate pressure build-up and flow of liquefied diesel fuel, while gaseous fuels bypass spill valve 24 and control valve 26. Solenoids 42, 44 housed adjacent to the valves receive electrical signals and power which cause the solenoids 42, 44 to actuate, opening or closing an associated valve. Closing a valve may build pressure in a chamber housing fuel, and opening a valve releases fuel under pressure. Fuel is eventually injected through an orifice of the injector, such as one or more nozzles in nozzle end portion 20. Fuel injectors, such as fuel injector 12, may include multiple solenoids to actuate multiple associated valves, and additional wires may be included to transmit signals and power to the multiple solenoids. Fuel injector 12 may include one or more sensors that collect and transmit data to controller 14. Additional wires may be included to collect data using the multiple sensors.

Assembly of fuel injector 12 may include stacking of plates and valve bodies within injector housing 16 in order, starting with control valve body 28, followed by solenoid body 30, which includes solenoids 42 and 44. Wires may extend from solenoid body 30 towards the proximal end 18 of fuel injector 12. The remaining stacked elements (e.g., spill valve body 32, seal 40, spill plate 34, and compression nut 36) include and define passageway 38, through which the wires are conveyed during assembly. Following placement of solenoid body 30, spill valve body 32 is stacked proximal to solenoid body 30. Lower sealing member 62 of seal 40 is urged into and secured in wire passageway 38 of spill valve body 32 against step 64. Upper sealing member 58 and central sealing member 60 may be urged into and secured in spill plate 34. Spill plate 34, including upper sealing member 58 and central sealing member 60, is stacked proximal to spill valve body 32 and lower sealing member 62 of seal 40. Upper sealing member 58 and central sealing member 60 are placed proximal to lower sealing member 62, and passageway 38 in spill valve body 32 and spill plate 34 are aligned. Compression nut 36 is screwed into place, which forces all the elements in injector housing 16 together. Forcing spill plate 34 and spill valve body 32 together with seal 40 situated between spill plate 34 and spill valve body 32 and within passageway 38 causes seal 40 (e.g., central sealing member 60) to be distorted (e.g. via compression) under the force and effectively seal passageway 38 such that fuel is not leaked at the interface between spill plate 34 and spill valve body 32 or at any point within passageway 38. Further, the compression of seal 40 may form an interference fit of wires 56 within the lumens of seal 40, thus securing the wires 56 to seal 40.

The disclosed fuel injector design with seal 40 may prevent undesired and/or unanticipated leakage of fuel between spill plate 34 and spill valve body 32. Seal 40 seals the interface between spill plate 34 and spill valve body 32, as well as passageway 38 used to house wires 56. Seal 40 may also be used to anchor wires 56 to avoid undesirable movement and pulling of wires 56 (e.g., due to vibrations caused by the engine). Such movement and pulling of wires 56 may lead to poor connections and missed actuations of the solenoids, which may result in failed injections. Seal 40 may also provide wires 56 with isolation from external vibration caused by the engine, such as by absorbing some of the vibrations. Absorbing such vibrations also adds to the sealing ability of seal 40. The use of seal 40 in fuel injector 12 may also avoid the need for a male/female-type wire connector. Such use of a male/female-type wire connector may lead to leaking due to the poor vibration absorption and lack of a proper seal.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A fuel injector, comprising:
a body assembly having a proximal end and a distal end comprising a nozzle;
an electronically operated valve situated within the body assembly, the electronically operated valve comprising a plurality of electrical wires;
a passageway configured to convey electrical wires from the electronically operated valve proximally through the fuel injector and out the proximal end and external to the body assembly; and
a seal situated within the passageway and distal a proximal end of the passageway, the seal surrounding the plurality of electrical wires.

2. The fuel injector of claim 1, wherein the body assembly comprises a first injector plate and a second plate in stacked relation, and wherein the passageway extends through the first plate and the second plate in a proximal-distal direction.

3. The fuel injector of claim 2, wherein the seal is situated within both the first plate and the second plate.

4. The fuel injector of claim 2, wherein the first plate comprises a first step within the passageway, wherein the second plate comprises a second step within the passageway, and wherein the seal abuts at least one of the first step or the second step.

5. The fuel injector of claim 4, wherein the seal abuts both the first step and the second step.

6. The fuel injector of claim 1, wherein the seal comprises a plurality of lumens extending completely through the seal from a seal proximal end to a seal distal end.

7. The fuel injector of claim 1, wherein the seal comprises a plurality of individual members.

8. The fuel injector of claim 7, wherein the seal comprises three individual members.

9. The fuel injector of claim 1, wherein the seal includes a taper.

10. The fuel injector of claim 1, wherein at least a portion of the seal is formed of an elastomer material.

11. A fuel injector, comprising:
a body assembly comprising a proximal end and a distal end comprising a nozzle;
an electronically operated valve situated within the body assembly, the electronically operated valve comprising a plurality of electrical wires having a distal end connected inside the body assembly and a proximal end extending outside the body assembly to an electrical connector;
a passageway configured to convey the plurality of electrical wires from the electronically operated valve proximally through the body assembly to the proximal end of the body assembly; and
a seal situated within the passageway and comprising a plurality of lumens extending from a seal proximal end to a seal distal end, each of the plurality of lumens receiving a wire of the plurality of electrical wires.

12. The fuel injector of claim 11, wherein the body assembly comprises a first plate and a second plate in stacked relation, and wherein the passageway extends through the first plate and the second plate in a proximal-distal direction.

13. The fuel injector of claim 12, wherein the seal is situated within both the first plate and the second plate.

14. The fuel injector of claim 13, wherein the seal comprises a plurality of individual members, and wherein one of the plurality of individual members extends across an interface between the first plate and the second plate.

15. The fuel injector of claim 12, wherein the first plate comprises a first step within the passageway, wherein the second plate comprises a second step within the passageway, and wherein the seal abuts at least one of the first step or the second step.

16. The fuel injector of claim 11, wherein the seal comprises a plurality of individual members.

17. The fuel injector of claim 16, wherein the seal comprises three individual members.

18. The fuel injector of claim 16, wherein one of the plurality of individual members of the seal comprises a taper.

19. The fuel injector of claim 11, wherein at least a portion of the seal is formed of an elastomer material.

20. A fuel injector, comprising:
a body assembly comprising a proximal end and a distal end comprising a nozzle;
an electronically operated valve situated within the body assembly, the electronically operated valve comprising a plurality of electrical wires having a distal end connected inside the body assembly and a proximal end extending outside the body assembly to an electrical connector;
a passageway configured to convey the plurality of electrical wires from the electronically operated valve proximally through the body assembly to the proximal end of the body assembly; and
a seal situated within the passageway and distal a proximal end of the passageway, the seal comprising:
a plurality of individual members; and
a plurality of lumens extending from a seal proximal end to a seal distal end, each of the plurality of lumens receiving a wire of the plurality of electrical wires.
